(19) United States
(12) Patent Application Publication
(10) Pub. No.: US 2015/0078297 A1
(43) Pub. Date: Mar. 19, 2015

(54) METHOD OF RESOURCE ALLOCATION FOR DEVICE TO DEVICE COMMUNICATION, USER EQUIPMENT USING THE SAME AND BASE STATION USING THE SAME

(71) Applicant: Industrial Technology Research Institute, Hsinchu (TW)

(72) Inventor: Yan-Xiu Zheng, Hsinchu County (TW)

(21) Appl. No.: 14/485,813

(22) Filed: Sep. 15, 2014

Related U.S. Application Data
(60) Provisional application No. 61/879,129, filed on Sep. 17, 2013.

(51) Int. Cl. H04W 72/04; H04W 56/00; H04W 76/02

(52) U.S. Cl. CPC H04W 72/044; H04W 76/023; H04W 56/001
USPC 370/329

(57) ABSTRACT

The present disclosure is directed to a method of resource allocation for device to device (D2D) communication, a user equipment using the same method, and a base station using the same method. In one of the exemplary embodiments, the disclosure would include a UE receiving a group of wireless signals, the UE determining from the group of wireless signals a first signal that has the highest power, the UE transmitting a second signal comprising the first signal that has the highest power to a base station, and the UE receiving a D2D resource allocation from the base station based on the second signal in response to transmitting the second signal. The first signal detected with the highest power may belong to a synchronous head.

### CROSS REFERENCE TO RELATED APPLICATION

This application claims the priority benefit of U.S. provisional application Ser. No. 61/879,129, filed on Sep. 17, 2013. The entirety of the above-mentioned patent application is hereby incorporated by reference herein and made a part of specification.

### TECHNICAL FIELD

The present disclosure is directed to a method of resource allocation for device to device communication, a user equipment using the same method, and a base station using the same method.

### BACKGROUND

Device to Device (D2D) or Peer to Peer (P2P) communication is a blossoming technology for future communication systems and enables user equipment (UE) to directly communicate with another without requiring a base station to relay user data in between. To multiplex among users for D2D communications, various schemes including time division multiplex (TDM) or frequency division multiplex (FDM) have been considered. TDM resource allocation could be utilized because of its simplicity, less inter-user interferences, single timing tracking, and so forth. The IEEE 802.11 for example applies the TDM solution. However, since the TDM solution applies to a whole band, transmission power is spread to the whole band and transmission range is limited to how large the bandwidth is applied.

Alternatively, the FDM approach may multiplex multiple users to use the same time slot by transmitting signals in different channels of a frequency spectrum with a narrower bandwidth used for each user. However, FDM would typically result in multi-user interferences. In particular, if a device receives two signals from two users for example, the larger received power may suppress the lower received power.

The other case related to D2D communication is the variation of signal arrival times for difference devices. As there are many D2D UEs with different inter-distances among different D2D UE pairs, each of the different D2D communication pairs would result in a different propagation delay. If propagation delays among D2D communication pairs are too large, extra receiver complexities may be necessary.

### SUMMARY OF THE DISCLOSURE

The present disclosure is directed to a method of resource allocation for device to device (D2D) communication, a user equipment using the same method, and a base station using the same method.

In one of the exemplary embodiments, the present disclosure is directed to a method of resource allocation for D2D communication that is applicable to a user equipment. The method would include at least but not limited to receiving a group of wireless signals, receiving from the group of wireless signals a first signal that has a highest power, transmitting a second signal comprising the first signal that has the highest power, and receiving a D2D resource allocation based on the second signal in response to transmitting the second signal. The first signal detected with the highest power may belong to a synchronous head.

In one of the exemplary embodiments, the present disclosure is directed to a user equipment that includes at least but not limited to a transmitter for transmitting wireless signal, a receiver for receiving wireless signal, and a processor coupled to the transmitter and the receiver and is configured for receiving via the receiver a group of wireless signals, receiving from the group of wireless signals a first signal that has a highest power, transmitting via the transmitter a second signal comprising the first signal that has the highest power, and receiving via the receiver a device to device (D2D) resource allocation in response to transmitting the second signal. The first signal detected with the highest power may belong to a synchronous head.

In one of the exemplary embodiments, the present disclosure is directed to a method of resource allocation for D2D communication that is applicable to a base station. The method would include at least but not limited to receiving a group of wireless signals, wherein each of the group of wireless signals comprises a report, wherein the report comprises a set of signals which have been received, receiving from the group of wireless signals a first signal that has a highest power, and transmitting a second signal comprising a D2D resource allocation based on the first signal in response to receiving the group of wireless signals. The first signal detected with the highest power may belong to a synchronous head.

In one of the exemplary embodiments, the present disclosure is directed to a base station that includes at least but not limited to a transmitter for transmitting wireless signal, a receiver for receiving wireless signal, and a processor coupled to the transmitter and the receiver and is configured for receiving via the receiver a group of wireless signals, wherein each of the group of wireless signals comprises a report, wherein the report comprises a set of signals which have been received, receiving from the group of wireless signals a first signal that has the highest power, and transmitting via the transmitter a second signal comprising a D2D resource allocation based on the first signal in response to receiving the group of wireless signals. The first signal detected with the highest power may belong to a synchronous head.

In order to make the aforementioned features and advantages of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates an exemplary system architecture for D2D communication in accordance with the present disclosure.

FIG. 2 illustrates an exemplary FDM multiplexed resource allocation scheme in accordance with the present disclosure.

FIG. 3 is an example that illustrates a composition of two discovery signals in the time domain.

FIG. 4A & FIG. 4B illustrates an exemplary user equipment in accordance with the present disclosure.

FIG. 5A & FIG. 5B illustrates an exemplary base station in accordance with the present disclosure.

FIG. 6A & FIG. 6B illustrates a general concept and resource allocation for D2D UE in accordance with one of the exemplary embodiments of the present disclosure.

FIG. 7A-FIG. 7D illustrates a proposed reporting procedure in accordance with one of the exemplary embodiments of the present disclosure.

FIG. 8 illustrates placements of synchronous heads in accordance with one of the exemplary embodiments of the present disclosure.

FIG. 9 illustrates FDM based resource allocation according to a synchronous head in accordance with one of the exemplary embodiments of the present disclosure.

FIG. 10 illustrates TDM based resource allocation according to a synchronous head in accordance with one of the exemplary embodiments of the present disclosure.

FIG. 11 illustrates implicit resource allocation according to a synchronous head in accordance with one of the exemplary embodiments of the present disclosure.

FIG. 12 illustrates hierarchical synchronization in accordance with one of the exemplary embodiments of the present disclosure.

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

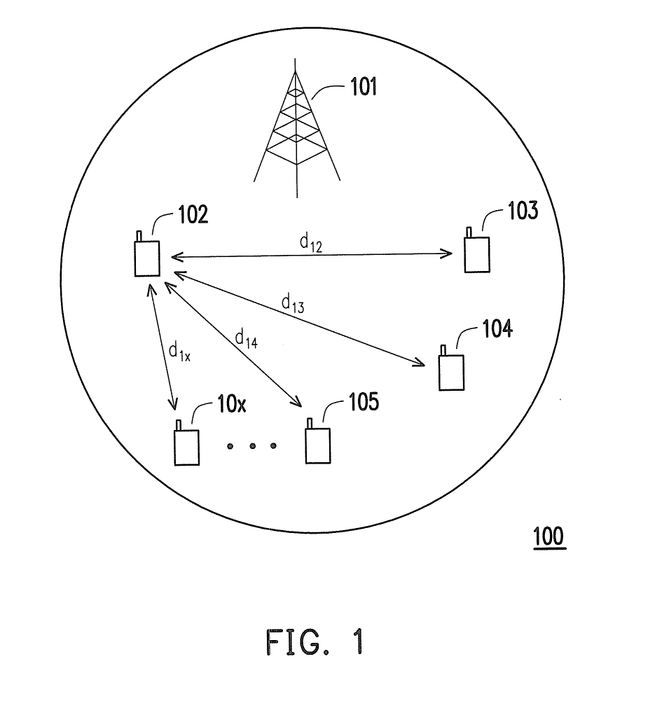

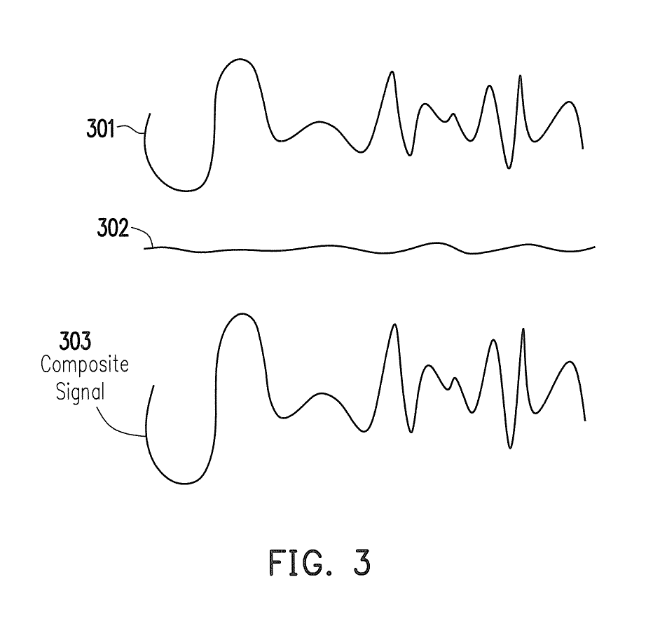

When operating under timing synchronous D2D communication, there could be different pairs of D2D UEs having different inter-distances. First of all, it has been well known that the near-far effect may induce signal imbalances which would cause various D2D UEs to suffer from signal suppression as the result of automatic gain control (AGC) and analog to digital (A/D) converter to further filter weaker discovery signals. Second, different inter-distances among D2D communication pairs may also introduce different timing propagation delays and the associated reception performance losses. In order to reduce the effects coming from different inter-distances, a resource allocation mechanism is necessary for device discovery. These aforementioned case could be further elaborated according to FIG. 1˜FIG. 3 and their corresponding written descriptions.

FIG. 1 illustrates an exemplary system architecture for D2D communication in accordance with the present disclosure. A D2D communication system architecture 100 would include at least but not limited to a base station 101 (or a cluster head) and a plurality of UEs 102˜10× which may possess D2D capabilities. A cluster head could be a small cell base station, a peer device, or a remote radio head. The plurality of UEs 102˜10x may first synchronize with an external device such as the base station 101 to acquire coarse timing references, and then UEs 103˜10x would be able to transmit signals such as discovery signals to a leading UE such as the UE 102.

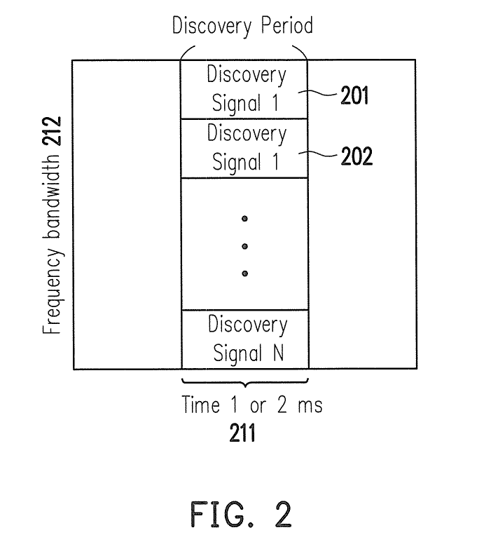

In one of the exemplary embodiments, one resource allocation scheme for the scenario of FIG. 1 could be illustrated by FIG. 2. According to FIG. 2, the plurality of UEs 103˜10x could be allocated D2D resource to transmit signal by the base station 101. The allocated D2D resource may include a resource with a specific time slot 211 and a frequency bandwidth 212 to transmit discovery signals. The specific time slot could be, for example, about one or two milliseconds. Within the time slot 211, each of the UEs 103˜10x may have a dedicated frequency domain resource transmit a discovery signal. For example, UE 103 may transmit a discovery signal at a first frequency band 201, and UE 104 may transmit a discovery signal at a second frequency band 202.

However, if one discovery signal is significantly weaker than the other. In that case, the weaker signal could be suppressed or eliminated to become undetectable after digitized by an A/D converter. FIG. 3 is an example that illustrates a composition of two discovery signals in the time domain. Assuming that after the UE 103 transmits a first discovery signal 301, and the UE 104 transmits a second discovery signal 302, the composite signal 303 received by the UE 102 would be the first discovery signal 301 and the second discovery signal 302 superimposed with each other as illustrated in FIG. 3. In this case, the second discovery signal 302 which is significantly weaker than the first discovery signal 301 could be practically indiscernible.

Furthermore, if the inter-distances d12, d13,˜d1x among UE D2D pairs have large variations among them. In this case, the receiver of the UE 102 would need to be unnecessarily complex.

Therefore, the present disclosure proposes arranging D2D UEs to be close to one synchronous head to perform D2D communications. A synchronous head could be any peer device assigned by a base station or a small cell base station in order to serve as a device for synchronization or data relay. For example, under the proposed circumstance, D2D UEs assigned by a base station to be served under a leading UE or synchronous head would transmit discovery signals at about the same time. Since the these D2D UEs assigned by a base station to a synchronous head are close to one another, the timing arrivals and power fluctuations will be limited to a fixed range. In other words, there would be significantly less timing arrival differences or less dynamic range of power fluctuations at receptions relative to the scenario without a synchronous head. In this way, a D2D UE would also be able to receive signals with higher power and greater signal to noise ratio than the scenario without having a synchronous head.

In this disclosure, 3GPP-like keywords or phrases are used merely as examples to present inventive concepts in accordance with the present disclosure; however, the same concept presented in the disclosure can be applied to any other systems such as IEEE 802.11, IEEE 802.16, WiMAX, and so like by persons of ordinarily skilled in the art. For exemplary purposes, a LTE communication system would be used as examples for the rest of the disclosure. Therefore, as an example a base station under a LTE system would typically be an evolved Node B (eNB).

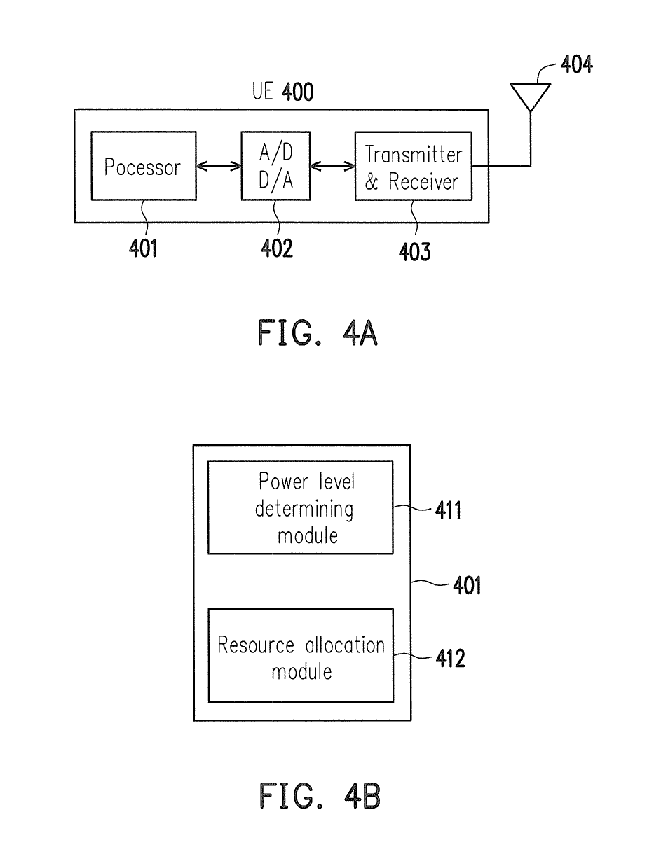

FIG. 4A illustrates an exemplary user equipment 400 in accordance with the present disclosure. The term “user equipment” (UE) in this disclosure may be, for example, a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and the like. In some applications, a UE may be a fixed computer device operating in a mobile environment, such as a bus, a train, an airplane, a boat, a car, and so forth.

The exemplary UE 400 may contain at least but not limited to a transceiver circuit 403 (or a transmitter and receiver), an analog-to-digital (A/D)/digital-to-analog (D/A) converter 402, and a processor 401 (or a processing circuit). The transceiver circuit 403 transmits and receives signals wirelessly. The transceiver 403 circuit may also perform operations such as low noise amplifying, impedance matching, frequency mixing, up or down frequency conversion, filtering, amplifying, and so like. The A/D/D/A converter 402 is electrically coupled to the transceiver circuit 403 and would be able to convert from an analog signal format to a digital signal format or from a digital signal format to an analog signal format.

The processor 401 would be electrically coupled to the A/D/D/A converter 402 and would be configured to process digital signal and to perform at least but not limited to functions related to the proposed method of resource allocation for device to device (D2D) communication in accordance with exemplary embodiments of the present disclosure. The functions of the processor 401 could be implemented using programmable units such as a micro-processor, a micro-controller, a DSP chips, FPGA, etc. The functions of the processor 401 could be integrated under one electronic device or one integrated circuit (IC) but may also be implemented with separate electronic devices or ICs.

The processor 401 may further include at least but not limited to a power level determining module 411 and a resource allocation module 412 as illustrated in FIG. 4B. In response to the transceiver circuit 403 receiving a group of signals within a time period, the power level module 411 may discern from the group of signals at least one signal having the maximum power. As for the resource allocation module 412, in response to receiving resource allocations for D2D communication via the transceiver circuit 403, the resource allocation module 412 would know the time and frequency domain resource to use for D2D communication. In another exemplary embodiment, the resource allocation module 412 has a table such that after being assigned to a specific synchronous head, the resource allocation module 412 would implicitly know what time domain and frequency domain could be used for D2D communication.

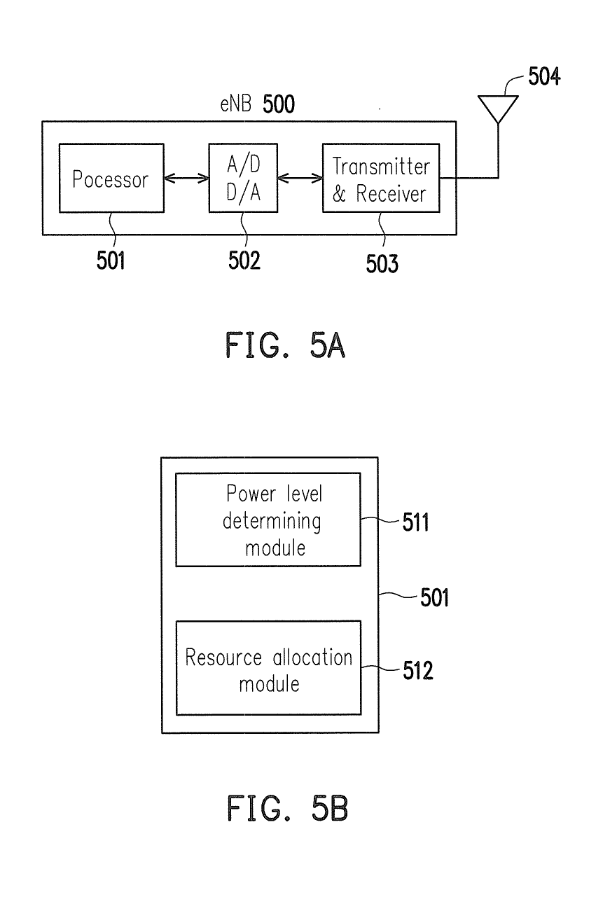

FIG. 5A & FIG. 5B illustrates an exemplary base station 500 in accordance with the present disclosure. The term “base station” in this disclosure may also be, for example, an evolved node B (eNB), a macro BS, a micro BS, a pico BS, a Node-B, an advanced base station (ABS), a base transceiver system (BTS), an access point, a home base station, a home eNB, a relay station, a scatterer, a repeater, an intermediate node, an intermediary, satellite-based communication base stations, and so forth.

An exemplary eNB 500 would contain at least but not limited to a transceiver 503 circuit (or a transmitter and receiver), an analog-to-digital (A/D)/digital-to-analog (D/A) converter 502, a processor 501 or processing circuit. The transceiver circuit 503 transmits and receives signals wirelessly. The transceiver circuit 503 may also perform operations such as low noise amplifying, impedance matching, frequency mixing, up or down frequency conversion, filtering, amplifying, and so like. The A/D/D/A converter 502 would be electrically coupled to the transceiver circuit 503 and would be able to convert from an analog signal format to a digital signal format or from a digital signal format to an analog signal format.

The processing circuit 501 would be electrically coupled to the A/D/D/A converter 502 and would be configured to process digital signals and to perform functions of the proposed method of resource allocation for device to device (D2D) communication in accordance with exemplary embodiments of the present disclosure. The functions of the processor 501 could be implemented using programmable units such as a micro-processor, a micro-controller, a DSP chips, FPGA, etc. The functions of the processor 501 could be integrated under one electronic device or one integrated circuit (IC) but may also be implemented with separate electronic devices or ICs.

The processor 501 may further include at least but not limited to a power level determining module 511 and a resource allocation module 512 as illustrated in FIG. 5B. In response to the transceiver circuit 503 receiving a group of signals within a time period with each of the group of signaling containing a report that records a group of signals received, the power level module 511 may discern from the group of signals at least one signal having the maximum power. As for the resource allocation module 512, in response to the group of signals via the transceiver circuit 503, the resource allocation module 512 would allocate time and frequency domain resource for each UE for D2D communication. In another exemplary embodiment, the resource allocation module 512 has a table such that after assigning a UE to a specific synchronous head, the resource allocation module 512 would implicitly know what time domain and frequency domain are used by the UE for D2D communication.

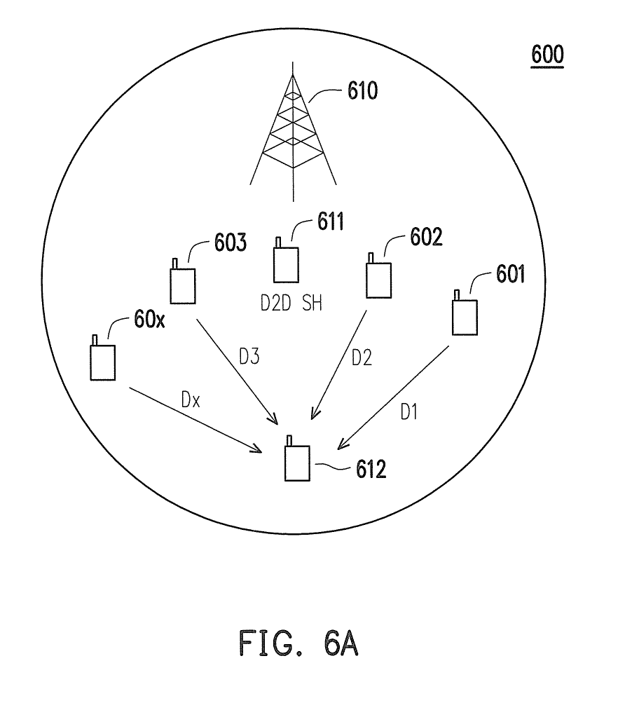

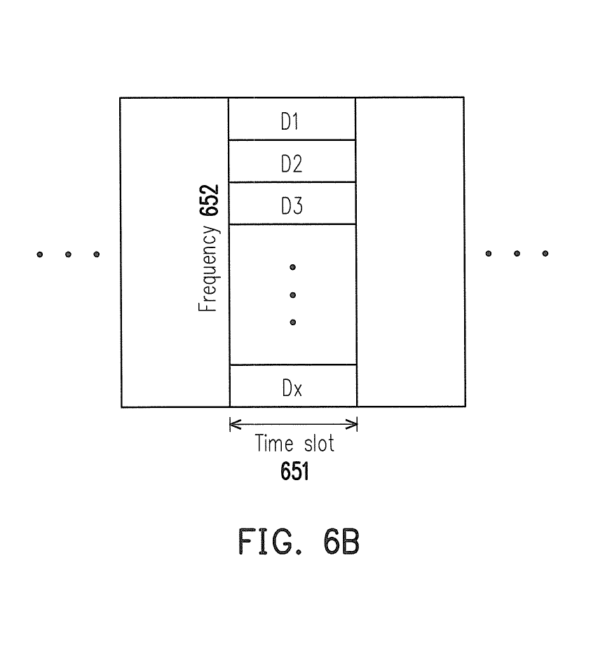

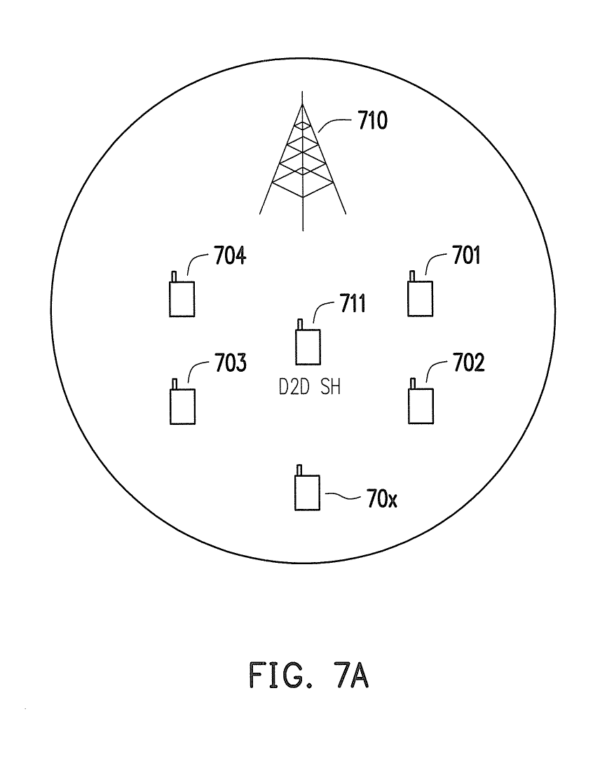

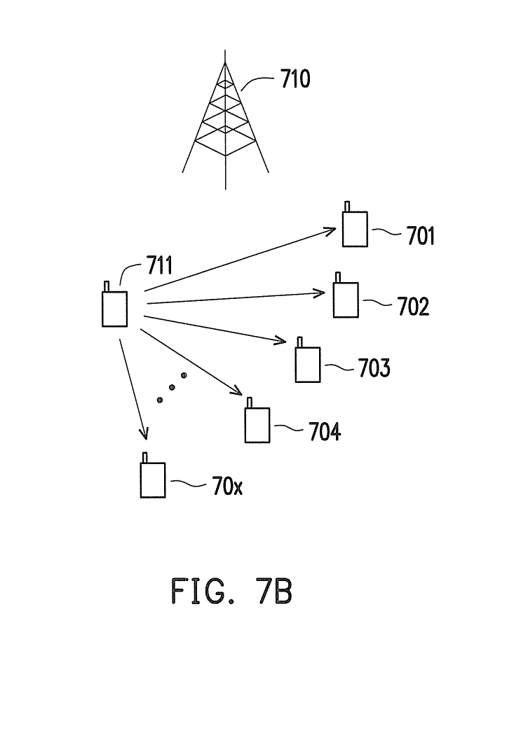

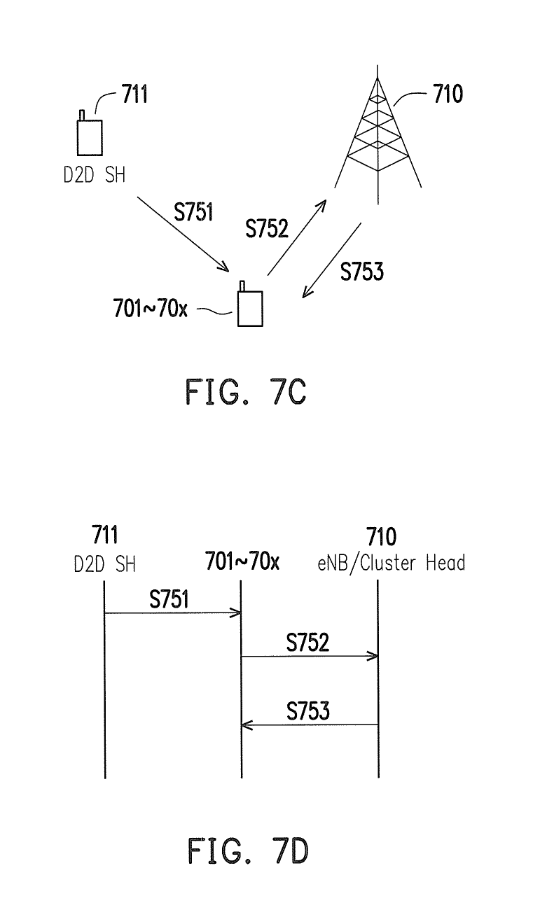

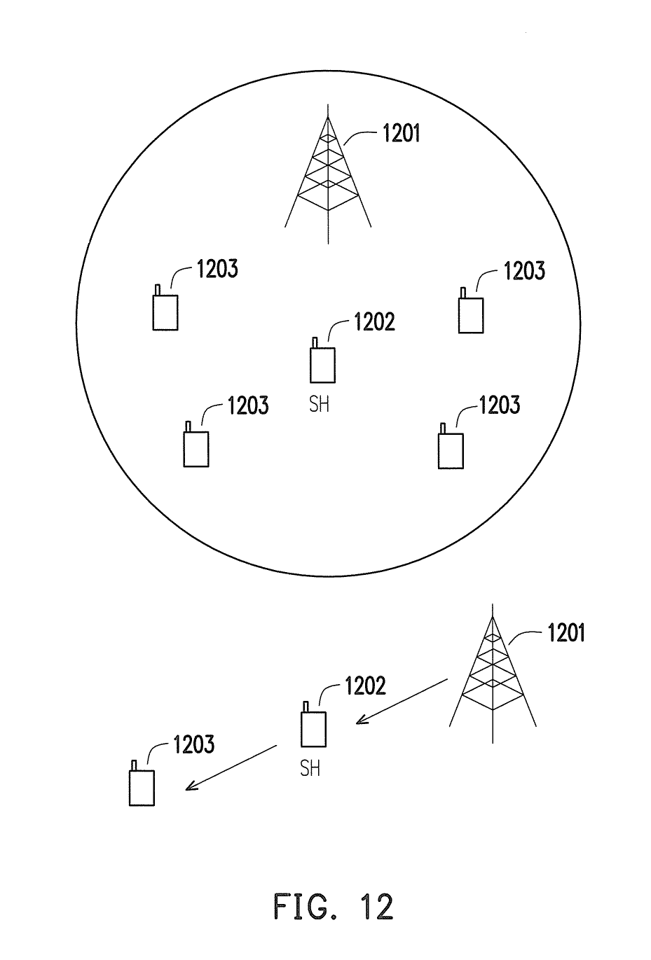

FIGS. 6A & 6B and their corresponding descriptions disclose the basic concept of the disclosure. FIG. 7A ˜FIG. 12 and their corresponding descriptions disclose further details and various embodiments of the present disclosure. Referring to the exemplary communication system 600 of FIG. 6A, a D2D UE 612 may establish synchronization with a base station 610 (or cluster head). A base station 610 may assign any UEs with D2D capabilities, such as UE 611 in FIG. 6A, to be a synchronous head. The D2D UE 612 could also detect one or more discovery signals from one or more synchronous heads and then report to the base station 610 one or more synchronous head having highest power. After UE 612 synchronizes with the base station 610, the base station may assign the UE 612 to the synchronous head, UE 611 assuming that the discovery signal of UE 611 received by UE 612 is among the ones with the highest power. The UE 612 would then be allocated D2D resource according to the synchronous head.

FIG. 6B illustrates resource allocation for D2D UEs 612, 601˜60x which are assigned to be served under the synchronous head 611 in accordance with one of the exemplary embodiments of the present disclosure. In general, all UEs which follow each synchronous head would be assigned a specific time slot 651 and a dedicated frequency band 652 that are allocated for that particular synchronous head. Within each time slot 651, each of the UEs would be assigned an unique frequency domain resource from the allocated frequency band 652 as D2D communication resource. For example, UE 601˜UE 60x could each transmit a discovery signal D1˜Dx according to FIG. 6A, and the discovery signal D1˜Dx could be transmitted by using the resource allocated as FIG. 6B. In this way, the transmitted discovery signals D1˜Dx are frequency domain multiplexed as they are close the synchronous head 611.

FIG. 7A˜FIG. 7D illustrates a proposed reporting procedure in accordance with one of the exemplary embodiments of the present disclosure. Assuming that an exemplary scenario of FIG. 7A would include a base station 710 (or cluster head) that has already assigned UE 711 as a synchronous head. UE 701˜70x are assumed to be under the domain of the base station 710 and could be closed to the synchronous head UE 711. As shown in FIG. 7B, since UE 701˜70x are allocated resources according to the synchronous head, UE 711, the inter-distances and signal strengths of signals received among the UE 701-70x would be within a specific threshold. Also all UEs that are allocated resources according to a synchronous head would have similar timing already synchronized with the base station 710.

FIG. 7C illustrates the reporting procedure in the scenario that is consistent with FIGS. 7A & 7B according one of the exemplary embodiments. FIG. 7D illustrates the reporting procedure in terms of a timing diagram according to one of the exemplary embodiments. FIG. 7C and FIG. 7D are referred together. In step S751, any one of the D2D UEs 701˜70x would listen to a group of discovery signals for different synchronous heads. Under a typical circumstance, there could be a group of discovery signals in the airwave. However, any one of the D2D UEs 701˜70x would select at least one discovery signal that has the highest power, and the discovery signal selected could only come from a synchronous head. In other words, a D2D UE would discern from one or more discovery signals and find one or more discovery signals of synchronous heads with the highest power. Assuming that the D2D UE 711 has been determined to be the synchronous head with the highest power, in step S752 a D2D UE among UEs 701˜70x would transmit a signal to the base station 710, and the signal would include the information that the D2D UE 711 was determined to be the synchronous head with the highest power. The signal may also include one or more other UEs as synchronous heads having the largest power. In step S753, the base station 710 would allocate D2D resource for the one of the D2D UEs 701˜70x that transmitted the signal in step S752, and the allocated resource would be associated with the synchronous head, the D2D UE 711. The resource allocation scheme will be further elaborated in FIG. 9˜11 and their corresponding descriptions.

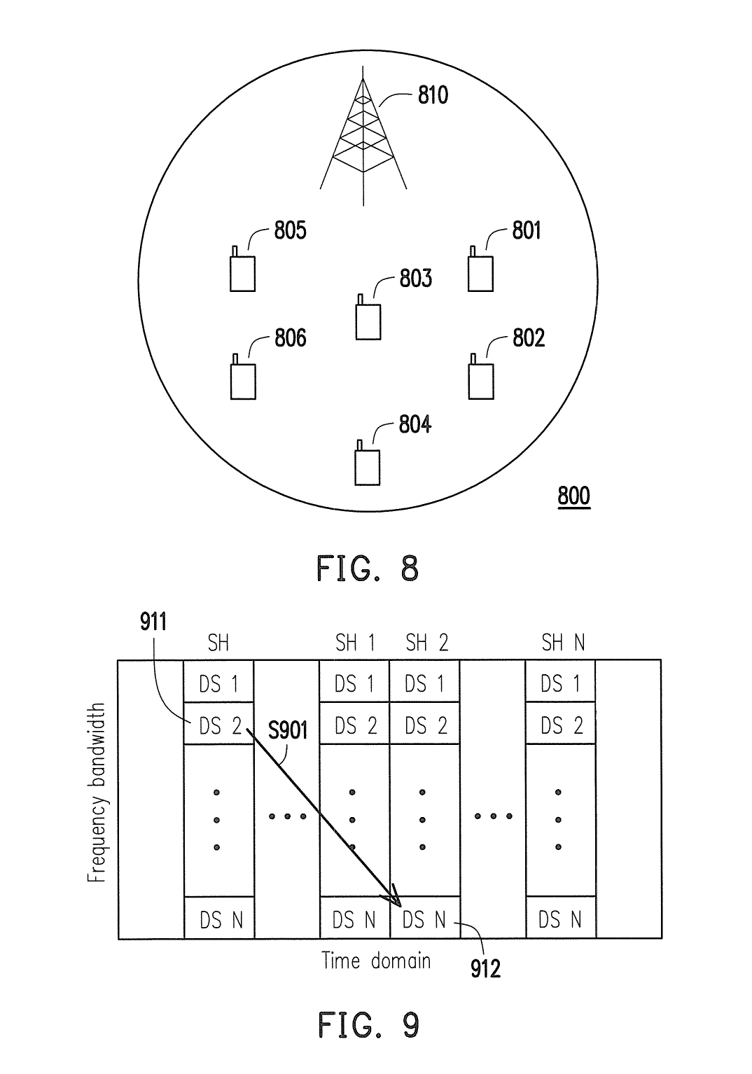

A synchronous head could be assigned by a base station based on location. For example, according to FIG. 8, synchronous heads 801˜806 are selected by the base station 810 to spread out as far as possible in order to maximize coverage areas within a macro cell. The synchronous head could be a small cell or a cluster head. When small cell is used as synchronous head, a D2D UE may measure received power from one or more synchronous heads 801˜806 and reports to the base station 810 the associated synchronous head that could be allocated radio resource under according to the received powers. When cross small cell resource allocation is considered, the resources among different cells could be interleaved.

FIG. 9 illustrates FDM based resource allocation according to a synchronous head in accordance with one of the exemplary embodiments of the present disclosure. For this exemplary embodiment, radio resources allocated for a group of discovery signals of synchronous heads are FDM-multiplexed in a dedicated time slot. Radio resources allocated to UEs served under each synchronous head could be FDM-multiplexed within the time slot dedicated for each synchronous head. For example, it can be seen from FIG. 9 that in the time slot, SH, allocated for different synchronous heads, the group of discovery signals DS 1, DS 2, . . . , DS N, are transmitted on different carrier frequencies. Assuming that synchronous head #2 has transmitted DS 2 that has been detected by a D2D UE as having the largest power, the synchronous head #2 could be reported to a base station as the preferred synchronous head for the D2D UE. The report may include an associated power level (e.g. −48 dBm). In response to receiving the report, in step S901, the base station may allocate an unique frequency domain resource, the radio resource 912 that is in the time slot SH 2 associated with synchronous head #2. The D2D UE could then utilize the allocated D2D resource 912 such as to transmit a discovery signal over the radio resource 912.

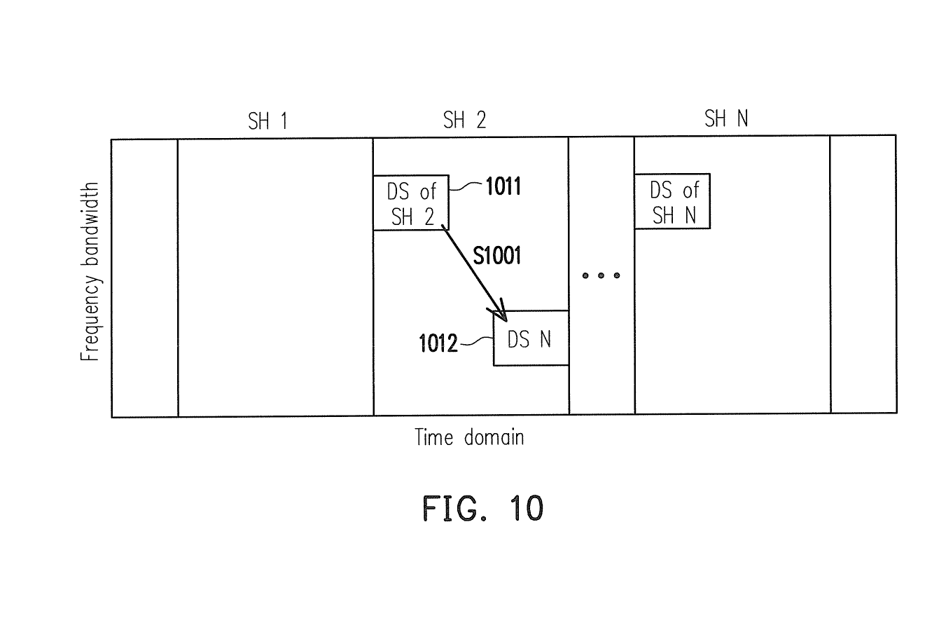

FIG. 10 illustrates TDM based resource allocation according to a synchronous head in accordance with one of the exemplary embodiments of the present disclosure. For this exemplary embodiment, radio resources allocated for a group of discovery signals of synchronous heads are TDM-multiplexed on different time slots. Radio resources allocated to UEs served under each synchronous head could be FDM-multiplexed within the time slot dedicated for each synchronous head. After a UE detects the group of discovery signals across various time slots, the UE could determine a discovery signal having the highest power. The UE could then report to a base station the preferred synchronous head that transmitted the discovery signal having the highest power. The base station would then allocate a radio resource to the UE in the time slot associated with the preferred synchronous head. For example, suppose that a UE has determined that the discovery signal 1011 of synchronous head #2 has the highest power and reported the determination to the base station with the associated power level, in step S1001, the UE could be allocated an unique frequency domain resource, the radio resource 1012 that is in the time slot SH2 associated with synchronous head #2 by the base station. The UE could then utilize the allocated D2D resource 1012 such as to transmit a discovery signal over the allocated D2D resource 1012. In other words, the UE may receive an unique frequency domain resource according to the synchronous head as the D2D resource allocation and transmits a discovery signal by using the unique frequency domain resource.

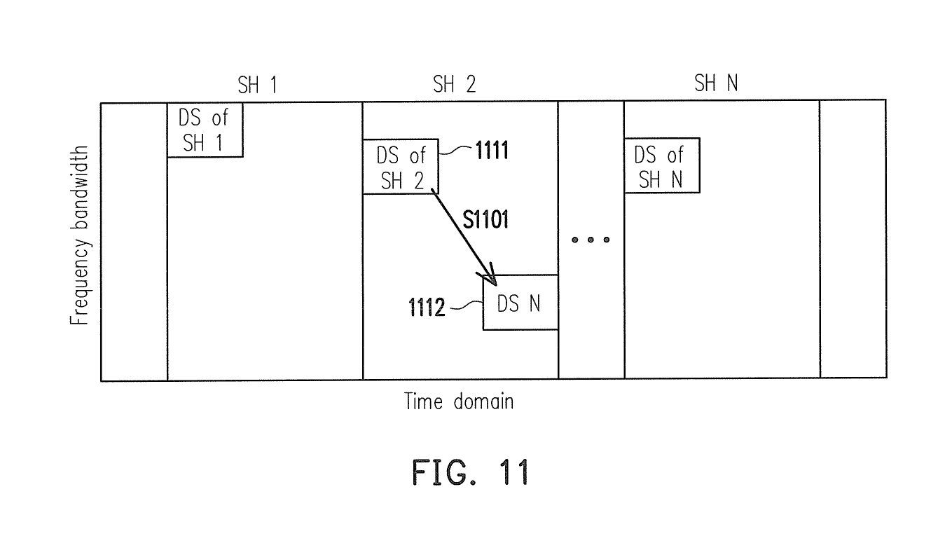

FIG. 11 illustrates implicit resource allocation according to a synchronous head in accordance with one of the exemplary embodiments of the present disclosure. Upon a UE reporting to a base station the synchronous head associated with a discovery signal having the highest power and associated power level, the UE would implicitly know the allocated radio resource without requiring the base station to allocated such radio resource. For example, a D2D UE may detect the power of discovery signals from different time slots and compare the power of discovery signals among each other to determine a discovery signal having the highest power. Assuming that the discovery signal 1111 of synchronous head #2 has been determined to be the discovery signal having the highest power and reported to the base station, in step S1101, implicitly the UE would know that the radio resource 1112 associated with synchronous head #2 would be implicitly assigned to be used. The UE could then utilize the radio resource 1112 such as to transmit a discovery signal.

As for the synchronization relationship between a base station, a synchronous head, and D2D UEs served under the synchronous head and the base station, a hierarchical synchronization scheme is proposed. FIG. 12 illustrates hierarchical synchronization in accordance with one of the exemplary embodiments of the present disclosure. For this exemplary embodiment, a synchronous head 1202 may synchronize with a base station 1201 so that the timing advance would be adjusted between the base station 1201 and the synchronous head 1202. A D2D UE such as one of UE 1203 could synchronize with the synchronous head 1202 to acquire reference timing. The D2D UE 1203 could measure the arrival signal from the base station 1201 and the synchronous head 1202 to adjust the timing difference. The D2D UE 1203 could sends signal timing advance to be the same as the synchronous head 1202 and maintain the similar timing advance as synchronous head 1202.

In one of the exemplary embodiment, the assignment of a synchronous head may not be static but could change from time to time. For example, assuming that a group of D2D UEs has been assigned by a base station to follow a synchronous head. The base station could choose one of the D2D UEs from this group to serve as the synchronous head instead, and the device that has previously been assigned as the synchronous head could then become one of the UEs of the group.

In one of the exemplary embodiments, an assigned synchronous head could be selected as a UE relay. In this way, the synchronous head may collect user data from a base station or from another UE targeted aimed toward a targeted UE. The synchronous head may then forward the collected user data for the targeted UE camping on this synchronous head. In the same way, the synchronous head may also forward user data from the targeted UE to a base station or to another UE.

In one of the exemplary embodiment, a synchronous head could be selected by a base station to serve as a cluster head to coordinate a group of D2D UEs.

In view of the aforementioned descriptions, the present disclosure is suitable for being used in a wireless communication system and is able to allocate D2D resources and achieve synchronization in such as a way that the near-far effect would be reduced and the variations of inter-distances among different UE pairs are minimized so that different timing propagation delays would not cause associated reception performance losses.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method of resource allocation for device to device (D2D) communication applicable to a user equipment, and the method comprising:
receiving a group of wireless signals;
receiving from the group of wireless signals a first signal that has a highest power, wherein the first signal detected with the highest power belongs to a synchronous head;
transmitting a second signal comprising the first signal that has the highest power; and
receiving a D2D resource allocation based on the second signal in response to transmitting the second signal.

2. The method of claim 1, wherein receiving the D2D resource allocation comprises:
receiving an assignment to be served under the synchronous head; and
receiving a time slot as the D2D resource allocation according to the synchronous head.

3. The method of claim 2 further comprising:
receiving an unique frequency domain resource according to the synchronous head as the D2D resource allocation.

4. The method of claim 3 further comprising:
transmitting a discovery signal by using the unique frequency domain resource.

5. The method of claim 1, wherein the group of wireless signals comprises a group of discovery signals, wherein each of the group of discovery signals is from a different synchronous head.

6. The method of claim 5, wherein each of the group of wireless signals is detected on different carrier frequencies.

7. The method of claim 5, wherein each of the group of wireless signals is detected on different time slots.

8. The method of claim 1 further comprising:
receiving an assignment as the synchronous head.

9. The method of claim 4 further comprising:
synchronizing with an external device; and
transmitting synchronization information in response to synchronizing with the external device.

10. The method of claim 4 further comprising:
relaying user data between difference external devices.

11. A user equipment (UE) comprising
a transmitter for transmitting wireless signal;
a receiver for receiving wireless signal; and
a processor coupled to the transmitter and the receiver and is configured for:
receiving via the receiver a group of wireless signals;
receiving from the group of wireless signals a first signal that has a highest power, wherein the first signal detected with the highest power belongs to a synchronous head;
transmitting via the transmitter a second signal comprising the first signal that has the highest power; and
receiving via the receiver a device to device (D2D) resource allocation in response to transmitting the second signal.

12. The UE of claim 11, wherein the processor is configured for receiving the D2D resource allocation comprises:
receiving via the receiver an assignment to be served under the synchronous head; and
receiving via the receiver a time slot as the D2D resource allocation according to the synchronous head.

13. The UE of claim 12, wherein the processor is further configured for:
receiving via the receiver an unique frequency domain resource according to the synchronous head as the D2D resource allocation.

14. The UE of claim 13, wherein the processor is further configured for:
transmitting via the transmitter a discovery signal by using the unique frequency domain resource.

15. The UE of claim 11, wherein the group of wireless signals comprises a group of discovery signals, wherein each of the group of discovery signals is from a different synchronous head.

16. The UE of claim 15, wherein each of the group of wireless signals is detected on different carrier frequencies.

17. The UE of claim 15, wherein each of the group of wireless signals is detected on different time slots.

18. The UE of claim 11, wherein the processor is further configured for:
receiving via the receiver an assignment as the synchronous head.

19. The UE of claim 14, wherein the processor is further configured for:
synchronizing with an external device; and
transmitting via the transmitter synchronization information in response to synchronizing with the external device.

20. The UE of claim 14, wherein the processor further configured for:
relaying user data between difference external devices through the transmitter and the receiver.

21. A method of resource allocation for device to device (D2D) communication applicable to a base station, and the method comprising:
receiving a group of wireless signals, wherein each of the group of wireless signals comprises a report, wherein the report comprises a set of signals which have been received;
receiving from the group of wireless signals a first signal that has a highest power, wherein the first signal detected with the highest power belongs to a synchronous head; and
transmitting a second signal comprising a D2D resource allocation based on the first signal in response to receiving the group of wireless signals.

22. The method of claim 21, wherein transmitting the D2D resource allocation comprises:
transmitting an assignment to be served under the synchronous head; and
transmitting the D2D resource allocation comprising a time slot according to the synchronous head.

23. The method of claim 22 further comprising:
transmitting the D2D resource allocation comprising an unique frequency domain resource according to the synchronous head.

24. The method of claim 21 further comprising:
transmitting an assignment as the synchronous head.

25. The method of claim 24 further comprising:
synchronizing with an external device; and
transmitting synchronization information in response to synchronizing with the external device.

26. A base station comprising:
a transmitter for transmitting wireless signal;
a receiver for receiving wireless signal; and
a processor coupled to the transmitter and the receiver and is configured for:
receiving via the receiver a group of wireless signals, wherein each of the group of wireless signals comprises a report, wherein the report comprises a set of signals which have been received;
receiving from the group of wireless signals a first signal that has the highest power wherein the first signal detected with the highest power belongs to a synchronous head; and
transmitting via the transmitter a second signal comprising a D2D resource allocation based on the first signal in response to receiving the group of wireless signals.

27. The base station of claim 26, wherein the processor is configured for transmitting the D2D resource allocation comprises:
transmitting via the transmitter an assignment to be served under the synchronous head; and
transmitting via the transmitter the D2D resource allocation comprising a time slot according to the synchronous head.

28. The base station of claim 27, wherein the processor is further configured for:
transmitting via the transmitter the D2D resource allocation comprising an unique frequency domain resource according to the synchronous head.

29. The base station of claim 26, wherein the processor is further configured for:
transmitting via the transmitter an assignment as a synchronous head.

30. The base station of claim 29, wherein the processor is further configured for:
synchronizing with an external device via the transmitter and receiver; and
transmitting via the transmitter synchronization information in response to synchronizing with the external device.
